(19) United States
(12) Patent Application Publication
(10) Pub. No.: US 2013/0062471 A1
(43) Pub. Date: Mar. 14, 2013

(54) INCLINED ORBIT SATELLITE COMMUNICATION SYSTEM

(71) Applicants: Wah L. Lim, Newport Beach, CA (US); Jeremiah Salvatore, Redondo Beach, CA (US)

(72) Inventors: Wah L. Lim, Newport Beach, CA (US); Jeremiah Salvatore, Redondo Beach, CA (US)

(21) Appl. No.: 13/112,117

(22) Filed: May 20, 2011

Related U.S. Application Data
(63) Continuation-in-part of application No. 12/657,188, filed on Jan. 14, 2010.
(60) Provisional application No. 61/396,087, filed on May 20, 2010.

(51) Int. Cl. B64G 1/10

(52) U.S. Cl. 244/158.6

(57) ABSTRACT

A method of flying a constellation of inclined geosynchronous satellites at the same station longitude with specific spacing but without the possibility of collision and provides the basic equations defining the initial positions of satellites such that the satellites will continue to remain in synchronized positions relative to each other for a number of years with little or no north-south positioning. In preferred embodiments the number of satellites in the constellation is five or ten. Communication with the satellites in the constellation is provided with existing prior art tracking radio systems.

### CROSS REFERENCE TO RELATED APPLICATIONS

This application is a continuation in part of Ser. No. 12/657,188, filed Jan. 14, 2010, which is incorporated herein by reference and claims the benefit of Provisional Patent Application 61/396,087 filed May 20, 2010.

### FIELD OF INVENTION

The present invention relates to communication systems utilizing geostationary communication satellites and in particular to those systems when the satellite is in an inclined orbit.

### BACKGROUND OF THE INVENTION

Typically geostationary satellites are maintained in an orbit position that is synchronized with the rotation of the earth so that the satellite appears to be in a stationary position above the surface of the earth. Transmit and received antennas on earth communicating with the satellite can therefore be maintained in a fixed position. To maintain the satellite in this geostationary position relative to the surface of the earth booster rockets must be fired periodically to correct the satellites position both east-west and north-south, each correction requiring booster rocket fuel. Much more fuel is required for the north-south correction than the east-west correction. At some point the satellite runs out of fuel which means the end of life for the satellite. A common practice toward the end of life, when fuel is low, is to correct for only ease-west deviations and allow the satellite to swing back and forth in its apparent north-south positions. The satellite will thus appear from fixed positions on earth to move back and forth in the north-south direction across the equator plane each day. The swing increases about 0.87 degrees per year. Various techniques have been proposed to permit earth bound antennas to track the satellites so as to extend the life of the communication system using the satellite. These prior art tracking systems are typically complicated and expensive.

Current state of the art ground antenna designed to receive signals from an inclined orbit geostationary satellite uses a tracking antenna that continuously track the movement of the satellite in inclined orbit that traces a FIG. 8 track in the sky. Because tracking antennas are expensive and complex, they prevent inclined orbit geostationary orbit satellite from being use for very small aperture satellite data services (VSAT) application and for direct to home satellite television (DTH) services.

Prior art patents relating to the subject matter of the present invention include U.S. Pat. No. 6,504,504 for fixed, multi-feed tracking antenna and U.S. Pat. Nos. 5,905,471 and 7,391,384 for active elements antenna. Other related patents include U.S. Pat. Nos. 4,538,175, 5,905,471, 6,952,188, 7,119,754, 5,859,620, 3,999,184, 4,739,337, 5,764,185, 4,035,805, 5,900,836, 7,119,754, 6,952,188, 5,077,561 and 5,075,682 relating to miscellaneous satellite receive antenna and tracking antenna. All of the above patents are incorporated herein by reference.

### Geostationary Satellite Operations

Most modern commercial communications satellites, broadcast satellites operate in geostationary orbits. (Russian television satellites have used elliptical Molniya and Tundra orbits due to the high latitudes of the receiving audience.) A geostationary orbit for a satellite is a geosynchronous orbit directly above the Earth's equator (0° latitude), with a period equal to the Earth's rotational period and a zero orbital eccentricity. Geostationary orbits can be achieved only very close to a ring 35,786 km (22,236 ml) directly above the equator. This requires an orbital velocity of 3.07 km/s (1.91 ml/s) for a period of 1436 minutes, which equates to almost exactly one earth day or ˜23.93 hours known as the sidereal day. Due to the constant 0° latitude and circularity of geostationary orbits, satellites in geostationary orbit differ in location by longitude only. This means that all geostationary satellites have to exist on this ring. Once the satellite is put into its orbital arc around the equator, the ground operators have to adjust the orbit location periodically in order to keep the satellite in its exact assigned position by a series of maneuvers call station-keeping. The reasons a geostationary satellite will not remain in place if no “station keeping” maneuvers are being performed periodically are because of forces acting on the satellite.

Geosynchronous/geostationary spacecraft motion, orbit perturbations and station-keeping maneuvers can be best understood by defining the orbit in terms of longitude, eccentricity and inclination vectors. The longitude vector has two components, longitude, L, and drift rate, d. The eccentricity vector has two components: magnitude of the eccentricity, e (a measure of the difference between apogee and perigee altitudes) and a direction pointing to perigee in inertial space (defined by the angle between perigee and the direction of Aries in the equatorial plane relative to the earth). FIG. 1 illustrates the e vector in the equator where the reference axis Aries represents the point where the sun rises above the equator on March 21. The inclination vector has two components: magnitude of the inclination, i (tilt of the orbit plane relative to the equator), and a direction pointing to the ascending in inertial space (defined by the angle between the point that a spacecraft rises above the equator and the direction of Aries in the equatorial plane as shown in FIG. 1. This angle is called the right ascension of the ascending node, RAi). The direction of the e vector (location of perigee) can then be defined by the sum angle RAi+w, where w is the classical element, the argument of perigee. The location of the spacecraft in the equatorial plane can then be defined by the sum angle RAi+w+M, where M is the classical element, mean anomaly.

FIG. 2 illustrates an edge view of the spacecraft orbit plane relative to the equatorial plane from the point of view of an inertial observer. These six components (L, d, e, RAi+w, i, RAi) are substitutes for the classical six elements (a, e, i, M, w, RAi) where a is the classical element, the semimajor axis. They permit a lucid discussion of (i) spacecraft motion at a mean station longitude, (ii) perturbations to the geosynchronous/geostationary orbit, and (iii) what standard station-keeping maneuvers are designed to accomplish.

The Sun enters Aries on the moment of vernal equinox by definition on March 21, leaving it on or about April 20. The relationship between longitude and both the e and i vectors can be established by first noting that the sunline in the equatorial plane rotates counterclockwise from Aries (after March 21) in FIG. 1 at ˜0.986 deg/day. On any day after March 21, the sun is at the Greenwich Meridian or zero longitude at 12 noon GMT. The right ascension of the sunline (RAs) on a typical day at this time (12 GMT) is shown in FIG. 1. If a spacecraft is “stationary” at L deg east longitude, it must be L deg ahead of the sunline at this time (12 GMT). The position of a spacecraft in FIG. 1 at any time of interest is:

SC position=RAi+w+M

The requirement for a spacecraft to be stationary at L deg east longitude requires:

RAi+w+M−RAs=L at 12 GMT on any day of the year or

w+M=L+RAs−RAi at 12 GMT on any day of the year

The time that the spacecraft arrives at the ascending node (w+M=0 deg) on any specific day is essential to defining the latitude timeline on that day since from FIG. 2, the latitude is approximately

Lat=i sin(w+M)

The angle (w+M) increases at a nearly constant rate of 360 deg/23.93 hr. The time of day that the spacecraft arrives at the ascending node is then defined as

TIME(i=0)=12 GMT−(L+RAs−RAi)(23.93 hr/360 deg)

Note that the advance of the right ascension of the sun every day makes the arrival of the spacecraft at the ascending node occur ˜4 minutes earlier each day. The right ascension of the ascending node of the spacecraft can vary due to orbital perturbations that will now be discussed.

### Satellite Station Keeping

To keep a geostationary satellite fixed in its intended orbit, a series of periodic manuevers must be performed using small on board thrusters rockets. Two primary sets of manuevers are: East-West control to keep the satellite near the longitude it is assigned and from drifting in the east-west direction, and North-South control to keep the satellite near zero latitude and not drifting in the north-south direction.

### East-West Motion, Perturbations, Station-Keeping

FIG. 5 illustrates the motion of both geosynchronous and geostationary spacecraft in the equatorial plane from the point of view of an earth fixed observer. The average diurnal spacecraft (SC) longitude is the center of an ellipse at synchronous radius; the semi major and semi minor axes are proportional to eccentricity. The SC instantaneous position moves clockwise along the ellipse and is defined by the mean anomaly, M, the angle of the spacecraft relative to perigee. The average longitude L of a geosynchronous/geostationary spacecraft is disturbed by “triaxiality” or the three dimensional ellipsoidal shape of the earth. There are only two stable longitudes (75 deg E, 254 deg E). Any spacecraft stationed at a longitude within +−90 deg of either of these nodes will drift towards toward the nearest stable longitude. The longitude of a spacecraft at any specific time can be defined as:

L=Lo+dt+2e(sin M)

where Lo is the east longitude at t=0, d is the instanteous drift rate, e is the current eccentricity, and M is the mean anomaly. The spacecraft is typically contained in an east/west longitude “box” of ^{˜}0.1 deg. Therefore, when any spacecraft exceeds one limit of this “box” due to drift toward the stable node, a maneuver is normally performed to send it to the opposite limit of the “box”.

These east/west maneuvers are somewhat complicated by solar pressure on the large solar panels and RF antennae. This disturbance advances the perigee perpendicular to the sunline and thus rotates the e vector away from Aries. Standard east/west station-keeping builds in an e vector that lags the sunline to account for this disturbance. This “sun synchronous” station-keeping only requires a single maneuver to change the drift direction and rotate the e vector to account for the solar perturbation between maneuvers. An alternative but also will known method performs two maneuvers each cycle to reverse the drift rate and maintain the eccentricity near zero. East/west station-keeping typically requires ^{˜}2 m/sec velocity increment per year that represents about 4% of the propellant required for geostationary station-keeping. This implies that spacecraft can operate in geosynchronous inclined orbits at very little propellant cost.

### North-South Motion, Perturbations, Station-keeping

FIG. 2 illustrates that the latitude of a geostationary spacecraft varies sinusoidally at diurnal rate with a maximum defined by the residual inclination. The spacecraft is typically contained in a north/south latitude “box” of 0.1 deg. The inclination i of a geosynchronous/geostationary spacecraft is disturbed by “gravity gradient” torques due to the sun, moon and earth equatorial bulge. The equator is oriented ^{˜}23 deg from the ecliptic plane, the path of the earth around the sun.

The differential pull of the sun over a year as the geostationary spacecraft orbits the earth in the equator increases the i vector magnitude by 0.27 deg along a direction 90 deg ahead of Aries; this differential pull over a year also regresses the i vector (rotates it clockwise with respect to Aries) 0.56 deg/yr. The moon is in an orbit that varies +−5 deg from the ecliptic over an 18.6 year period.

The differential pull of the moon over a year (smaller but closer) as the geostationary spacecraft orbits the earth in the equator increases the i vector magnitude by ^{˜}0.6+−0.124 deg along a direction 90 deg ahead of Aries; this differential pull over a year also regresses the i vector 1.23+−0.13 deg/yr. The earth's equatorial bulge does not change inclination but rather regresses the i vector 4.93 deg/yr. The total results from all three perturbations are

Delta i=0.87+−0.124 deg/yr along 90 deg ahead of Aries

Delta RAi=−6.72+−0.13 deg/yr

These perturbations result in an inclination change of ^{˜}0.1 deg every six weeks. The north/south maneuvers performed on geostationary spacecraft compensates for the inclination increase by moving the i vector to ^{˜}0.05 deg in a direction 90 deg behind Aries so that the north/south latitude “box” of +−0.05 deg is maintained. The small nodal regression during the station keeping cycle is negated at negligible cost. North/south station-keeping typically requires ^{˜}48 m/sec velocity increment per year and represents about 96% of propellant required for geostationary station-keeping.

### Satellite Radio Frequency

Modern telecommunications and earth observation satellites use radio frequency as a means of communications with the ground. The International Telecommunication Union (ITU), an agency of the United Nations, has set aside space in the super high frequency (SHF) bands located between 2.5 and 22 GHz for satellite transmissions. They are designated as: S band (2 to 3 GHz); C band (3 to 6 GHz); X band (7 to 9 GHz); Ku band (10 to 17 GHz); and Ka band (18 to 22 GHz). At these frequencies, the wave length of each cycle is so short that the signals are called microwaves. These microwaves have many characteristics of visible light: they travel directly along the line of sight from any satellite to its primary coverage area and are not impeded by the Earth's ionosphere.

The world's first commercial satellite systems used the C band frequency range of 3.7 to 4.2 GHz. By the late 1960s, many telephone companies around the world had numerous terrestrial microwave relay stations operating within the 3.7 to 4.2 GHz frequency range. The amount of power that any C-band satellite could transmit had to be limited to a level that would not cause interference to terrestrial microwave links.

The first commercial Ku band satellites made their appearance in the late 1970s and early 1980s. Relatively few terrestrial communications networks were assigned to use this frequency band; Ku-band satellites could therefore transmit higher-powered signals than their C-band counterparts without causing interference problems down on the ground.

Ku-band satellite antennas have a much narrower beam width, the corridor through which the dish looks up at the sky, than C-band parabolic antennas of a given diameter. There is a direct relationship between wavelength and antenna beam width: the shorter the wavelength, the narrower the beam width.

The International Telecommunication Union has assigned S-band frequency spectrum for direct-to-home (DTH) TV transmissions, and Indonesia is currently using this band for their DTH services. One limiting factor has been the bandwidth available: just 150 MHz of spectrum from 2.5 to 2.65 gigahertz.

### Fixed Satellite Services Business Overview

Operators for fixed services satellite (“FSS”), which is one of the most established in the satellite industry, provide satellite capacity for services between two fixed points (point-to-point services) and from one fixed point to multiple fixed points (point-to-multipoint services). Point-to-point applications include telephony, video contribution (also known as satellite news gathering) and data transmission (such as Internet backbone connectivity). Point-to-multipoint applications include broadcast applications such as video distribution and direct to home (DTH) services.

FSS satellites appear to remain at fixed locations in the sky and as a result, each FSS satellite provides communications coverage to a fixed geographic area. An earth station antenna on the ground can continuously communicate with a particular FSS satellite if it is pointed on a “line of sight” basis to the correct orbital location.

FSS satellites are typically evaluated on: The size and shape of their coverage area, or footprint, and its match with the desired contour of the customer, the frequency and strength of the signal transmitted to the coverage area and the availability of transponders for a given application. A key measurement of signal quality within a satellite's coverage area is the intensity of transmission power as measured by its effective isotropic radiated power (“EIRP”) at both beam center and edge of coverage. A higher EIRP, measured in decibel watts (“dBW”), enables the DTH service provider to use a smaller, lower-cost antenna on the ground. Customers will also evaluate a satellite's suitability by considering its remaining operational life and the number of available transponders capable of supporting the customer's unique applications. Customers also assess whether or not the satellite operator's fleet offers sufficient in-orbit backup and expansion capacity.

Today, FSS satellites typically operate in C-band and Ku-band. C-band frequencies (4 GHz to 8 GHz) have lower power and relatively longer wavelengths and as a result typically require larger antennas (3 meters to 12 meters). C-band frequencies are typically used for video distribution, telephony and certain other voice and data applications where small antenna size is not critical. Ku-band frequencies (12 GHz to 18 GHz) have higher power and relatively shorter wavelengths and can operate with smaller antennas (60 centimeters or less). Accordingly, Ku-band frequencies are well suited for consumer DTH satellite television, broadband Internet applications, very small aperture terminal (“VSAT”) networks and other applications where minimizing the size and cost of earth station terminals facilitates adoption. In the case of Indonesia, Southeast Asia and India, where rain attenuation can present a challenge, S-band (2 GHz to 4 GHz) can be used for consumer DTH satellite television applications because its lower frequency is well suited to local conditions.

### Ground Antenna in Geostationary Satellite Applications

### Antenna Types

### Parabolic Antennas

Most satellite ground antenna dishes incorporate a parabolic curve into the design of their bowl-shaped reflectors. The parabolic curve has the property of reflecting all incident rays arriving along the reflector's axis of symmetry to a common focus located to the front and center. The parabolic antenna's ability to amplify signals is primarily governed by the accuracy of this parabolic curve.

### Cassegrain Antennas

The cassegrain antenna is most often used for dishes that exceed five meters in diameter. Its use is primarily restricted to uplink earth stations and cable TV head ends. The cassegrain design incorporates a small sub reflector located at the front and center of the dish. The sub reflector deflects the microwaves back toward the center of the reflector, where the feedhorn is actually mounted. This type of antenna obtains higher efficiencies because the feedhorn looks up at the cold sky and the required illumination taper is reduced. This type of antenna are however expensive and complex and is not common for low cost application.

### Spherical Antennas

The spherical antenna design creates multiple focal points located to the front and center of the reflector, one for each available satellite. The curvature of the reflector is such that if extended it outward far enough along both axes it would become a sphere. Spherical antennas are primarily used for commercial television and cable installations where the customer wishes to simultaneously receive multiple satellites with a single dish. These satellites must be within +/−20 degrees of the reflector's axis of symmetry.

### Planar Arrays

Some digital DTH systems in Japan and elsewhere have elected to use an alternate antenna design called the planar array. These flat antennas do not rely on the reflective principles used by all parabolic dishes. Therefore no feedhorn is required. Instead a grid of tiny elements is embedded into the antenna's surface. These elements have a size and shape which causes them to resonate with the incoming microwave signals. One main disadvantage of the planar array is its limited frequency bandwidth which is about 500 MHz. Another disadvantage of the planar array is the high construction cost.

### Antenna Configurations

### Prime Focus Antennas

The basic design principle of the parabolic/spherical curve can be incorporated into antenna designs in a variety of ways. Dishes with a focal point directly at the front and center of the reflector are called prime focus antennas. Prime focus antennas are easy to construct and point toward the desired satellite. There are two main design disadvantages, however: the feedhorn and feed support structure block part of the reflector surface and the feedhorn must look back at the dish at such an angle that it can also intercept noise from the “hot” earth located directly behind the reflector.

### Offset-Fed Antennas

The dish design of choice for most digital DTH systems is called an offset-fed antenna. Here the manufacturer uses a smaller subsection of the same parabolic/spherical curve used to produce prime focus antennas, but with a major axis in the north/south direction, and a smaller minor axis in the east/west direction.

### Ground Receive Antenna Sensitivity

The ground receive antenna sensitivity is to first order dependent on the size of the antenna and the related wavelength of transmission. In general for a given size antenna, higher frequency has higher sensitivity. As the signal path moves off axis, the signal sensitivity drops off rapidly. Typical measure of sensitivity drop-off is the 3 db point. As an example, the following table illustrates the 3 db off axis signal drop-off of Ku, C and S bands.

TABLE
Antenna size vs. Look Angle Signal loss

| | | Antenna Gain (dbi) | | | (−3 bd) angle from look axis (deg) | | |
|---|---|---|---|---|---|---|---|
| Antenna Size | | Ku | C | S | Ku | C | S |
| 30 | cm | 30 | 20 | 16 | 3 | 9 | 13.7 |
| 60 | cm | 36 | 26 | 22 | 1.4 | 4.5 | 6.8 |
| 1.2 | m | 42 | 32 | 28 | 0.7 | 2.3 | 3.4 |
| 2.4 | m | 48 | 38 | 34 | 0.4 | 1.1 | 1.7 |
| 3.6 | m | 51 | 42 | 38 | 0.25 | 0.75 | 1.1 |
| 4.8 | m | 54 | 44 | 40 | 0.19 | 0.56 | 0.9 |

As an example, for a Ku DTH antenna of 120 cm in size, when the satellite in inclined orbit has an inclination greater than 0.7 degrees, at the extreme of the inclination, the ground antenna will have a sensitivity reduction of at least 3 db. For an S band DTH antenna of 120 cm in size when the satellite in inclined orbit has an inclination greater than 3.4 degrees, at the extreme of the inclination angle, the ground antenna will have a sensitivity reduction of at least 3 db. Since S band is less sensitivity to rain and weather, S band can withstand higher inclination without losing signal for normal service.

Theoretically, at 0.87 degree increase in inclination per year without North-South station keeping, an S band satellite providing DTH services will continue to provide service for approximately three years after North South fuel is depleted. With the implementation of a three feed antenna, one point at 0 degree, one at +2 degree and one at −2 degree, with the correct switching algorithm employed with this invention, an additional three to four years of useful service life can be obtain for a satellite at the end of fuel life.

What is needed is an inexpensive simple system for maintaining communication with inclined orbit geostationary satellites.

### SUMMARY OF THE INVENTION

The present invention provides a method of flying a constellation of inclined geosynchronous satellites at the same station longitude with specific spacing but without the possibility of collision and provides the basic equations defining the initial positions of satellites such that the satellites will continue to remain in synchronized positions relative to each other for a number of years with little or no north-south positioning. In preferred embodiments the number of satellites in the constellation is five or ten. Communication with the satellites in the constellation is provided with existing prior art tracking radio systems.

### BRIEF DESCRIPTION OF THE DRAWINGS

FIG. 1 is a sketch showing spacecraft eccentricity.

FIG. 2 is a sketch showing an edge view of spacecraft orbit plane.

FIG. 3 shows diurnal longitude and redial spacecraft motion in the equatorial plane due to eccentricity.

FIGS. 4A and 4B show Loci of solutions for identical radii or latitude with wᵢ=0 degrees.

FIGS. 5A and 5B show loci of solutions for identical radii or latitude with wᵢ=90 degrees.

FIGS. 6A and 6B show loci of solutions for identical radii or latitude with wi=180 degrees.

FIG. 7 shows a preferred embodiment in which a pentagon constellation of five satellites orbiting at the same geosynchronous longitude with radial or latitude separation everywhere and at all times.

### DETAILED DESCRIPTION OF PREFERRED EMBODIMENTS

### A Constellation of Geostationary Satellites at the Same Longitude

A Geostationary satellite typically operates at a specific station longitude (within a 0.2 deg “box”) separated from any adjacent satellite by a delta longitude dependent on transmission frequencies and operator. Satellites such as Directv can and do operate at longitudes with as little as a 0.1 deg separation. Inclination is typically maintained <0.1 deg. When the satellite is low on propellant or is “replaced”, north/south station keeping is typically terminated but east/west station keeping is continued to maintain the station longitude; this allows the satellite to become a “spare” with reduced capability because inclination is increasing ˜0.87 deg/yr. A new ground antenna concept (being developed under current contract) can switch feeds or linearly move the feed with a clock such that the “spare” Geosynchronous satellite has full capability for up to six years without north/south station keeping. An additional new ground antenna concept can digitally combine signals from multiple satellites at the same station longitude but with different inclinations. This leads to the question of how to fly a constellation of inclined geosynchronous satellites at the same station longitude with specific spacing but without the possibility of collision. The following analysis addresses the requirements for formation flying of such a constellation.

### The Basic Equations Defining the Position of a Geosynchronous Satellite

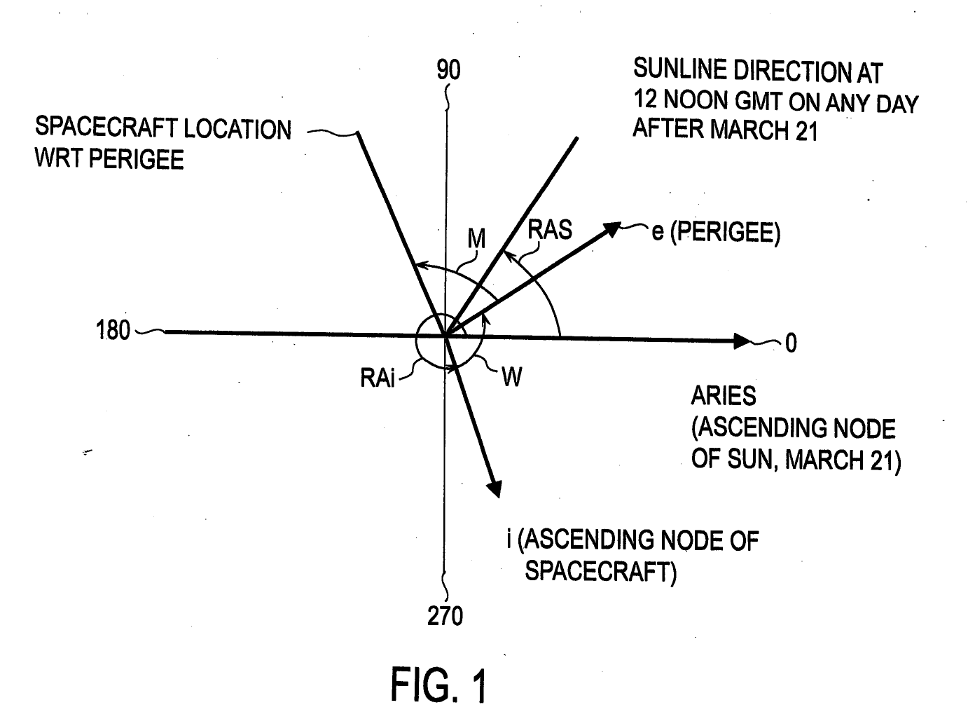

The angular position of a geosynchronous satellite in the equatorial plane can be defined in earth centered inertial coordinates (FIG. 1 where the XY plane is the equator and the X axis points toward Aries) at any time as:

SC equatorial angular position=RA+w+M

where RA=right ascension of the ascending node, w=argument of perigee, and M=mean anomaly. The requirement for a spacecraft to be at specific east longitude at 12 noon GMT on any given day is:

(RA+w+M)−sun longitude at 12 GMT=station east longitude

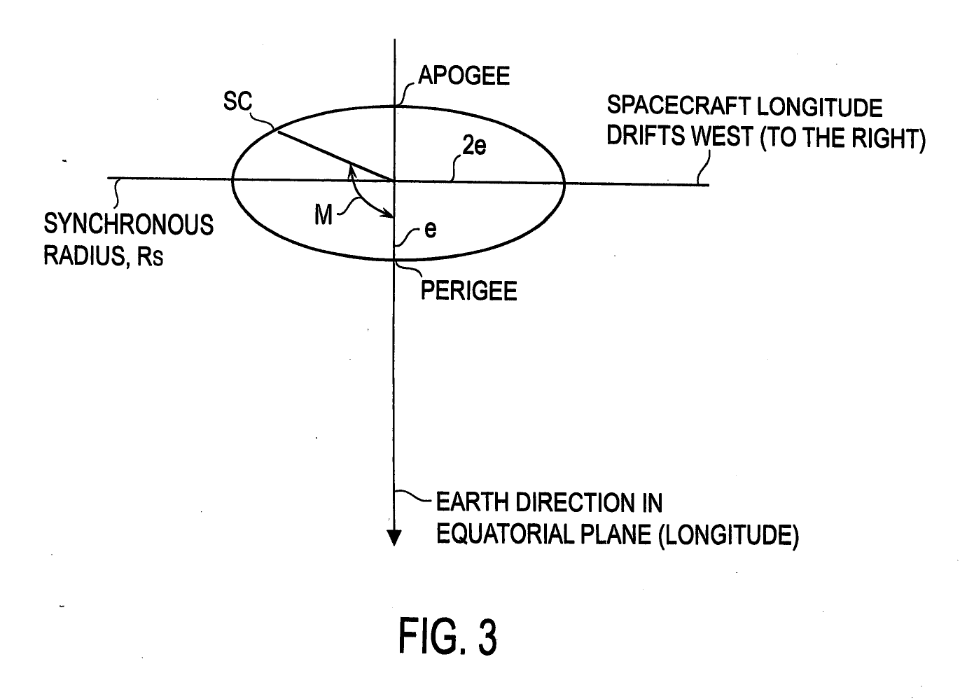

Therefore, all satellites in a constellation at the specific nominal station longitude must have an identical sum of (RA+w+M) at any time of day, since all rotate around the earth at the same geosynchronous rate. The instantaneous longitude, L, of a spacecraft at any specific time can by reference to FIG. 3 be defined as:

L=Lo+dt+2e*sin(M)

where Lo is the east longitude at t=0, d is the instantaneous drift rate in the “east/west” box, e is the current eccentricity, and M, mean anomaly, is the angular position of the spacecraft with respect to perigee. The difference in longitude of any two satellites 1&2 in the constellation can be defined as:

(L1−L2)=(Lo1−Lo2)+[2e1*sin(M1)−2e2*sin(M2)]

Since all satellites in the constellation share the same “east/west” box at the nominal station longitude, the possibility of L1=L2 can readily occur so that any attempt to preclude collision with longitude difference only is ill advised. Any two satellites in the constellation having different inclination will always have identical latitude at the two points where the orbital planes intersect. Any two satellites in the constellation having different eccentricity will always have identical radii at the two points where the non-planar ellipses intersect. The necessary and sufficient conditions to prevent any collision between satellites in the constellation are to guarantee radial separation at identical latitudes and latitude separation at identical radii. Any difference in longitude at these four points provides additional separation but is unnecessary to preclude collision.

### Differential Radius Between Two Inclined Geosynchronous Satellites

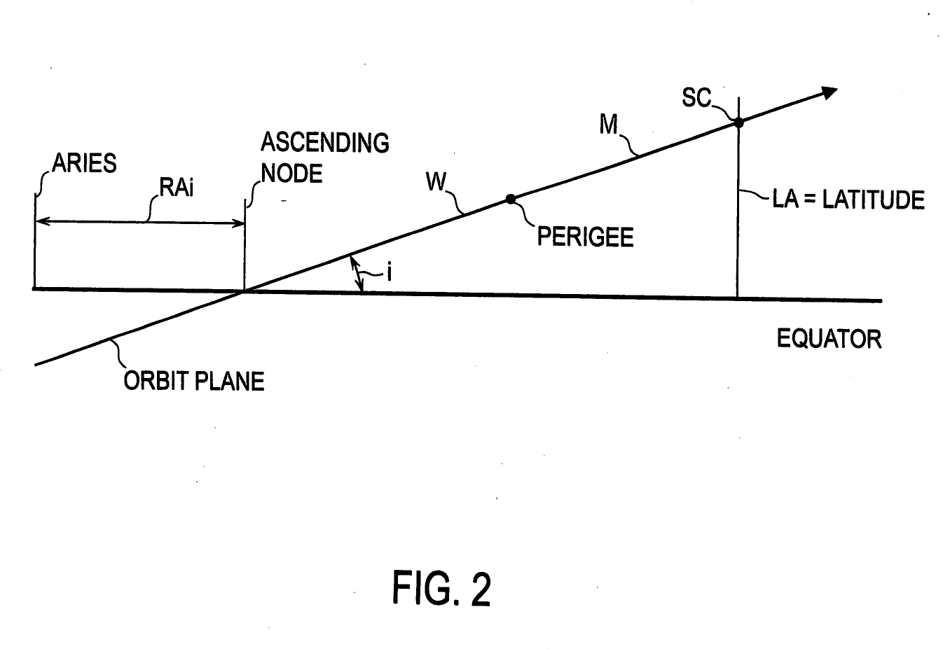

The instantaneous radius, R, of a geosynchronous spacecraft at any specific time can bt reference to FIG. 2 be defined as:

R=Rs*[1−e*cos(M)]

The difference in radius of any two satellites 1&2 in the constellation can be defined as:

Delta R=R2−R1=Rs*[e1*cos(M1)−e2*cos(M2)]

Noting from above that (RA1+w1+M1)=(RA2+w2+M2) at any point in the orbits of the two geosynchronous satellites, we can define this difference to be:

Delta R=Rs*e1*[cos(M2-delta RA-delta w)−(e2/e1)*cos(M2)]

Delta R=Rs*e1*[cos(M2)*{cos(delta RA+delta w)−(e2/e1)}+sin(M2)*sin(delta RA+delta w)]
where delta RA=(RA1−RA2) and delta w=(w1−w2).

We define the angle Q by

cos(Q)={cos(delta RA+delta w)−(e2/e1)}/MAG,

sin(Q)=sin(delta RA+delta w)/MAG
where MAGq=square root [1+(e2/e1)squared−2*(e2/e1)*cos(delta RA+delta w)]

Substitution of Q in the equation above defines the differential radius to be:

Delta R=Rs*e1*MAGq*cos(M2−Q)

There are two solutions where the radii of the two satellites are identical as expected at the non planar ellipse intersections. These two solutions are defined by:

(M2−Q)=90 deg, M2=Q+90 deg, M1=M2−delta RA−delta w Solution 1:

(M2−Q)=270 deg, M2=Q+270 deg, M1=M2−delta Ra−delta w Solution 2:

A graphic summary of when multiple geosynchronous satellites having different eccentricities, ascending nodes, and argument of perigees will have zero radial separation will be presented after we define when such satellites in the constellation can have zero latitude difference.

### Differential Latitude Between Two Inclined Geosynchronous Satellites

The instantaneous latitude, La, of a geosynchronous inclined satellite at any specific time can by reference to FIG. 2 be defined as:

La=i*sin(w+M).

The difference in latitude of any two satellites 1&2 in the constellation can be defined as

Delta La=i1*sin(wi+M1)−i2*sin(w2+M2).

Noting again that (RA1+w1+M1)=(RA2+w2+M2) at any point in the orbits of the two geosynchronous satellites, we can define the difference to be:

Delta La=i1*[sin(w1+M1)−(i2/i1)*(sin(w1+M1+delta RA)].

Delta La=i1*[sin(w1+M1)*{1−(i2/i1)*cos(delta RA)}−(i2/i1)*cos(w1+M1)*sin(delta RA)].

We define the angle Z by:

cos(Z)={1−(i2/i1)*cos(delta RA)}/MAGz

sin(Z)=(i2/i1)*sin(delta RA)/MAGz
where MAGz=square root[1+(i2/i1)squared−2*(i2/i1)*cos(delta RA)]

Substitution of Z in the equation above defines the differential latitude to be:

Delta La=i1*MAGz*sin(w1+M1−Z)

There are two solutions where the latitude of the two satellites are identical as expected at the intersection of the orbit planes. These two solutions are defined by:

(w1+M1−Z)=0 deg, w1+M1=Z, M2=M1+delta RA+delta w Solution 1:

(w1+M1−Z)=180 deg, w1+M1=180+Z, M2=M1+delta RA+delta w Solution 2:

Now that we have the all the requirements for identical radii and identical latitude as a function of relative eccentricity, relative inclination, relative right ascension and relative argument of perigee for two geosynchronous satellites in inclined orbits, we can specialize the equations to arrive at the requirements for formation flying of a constellation of inclined satellites at a fixed station longitude. We note first that there is a preferred set of right ascensions for the constellation along the 90/270 deg axis. The sun/moon gravity gradient torques increase inclination ˜0.87 deg/yr along a direction 90 deg ahead of Aries; aligning the nodes near this axis (small delta RA) helps maintain formation flying as inclination increases uniformly for the constellation. We note second that aligning perigees along the nodes insures radial separation near intersections of orbital planes, when the eccentricities differ.

### Loci of Identical Radii and Identical Latitude for Inclined Geosynchronous Satellites

In order to illustrate parametric curves defining the loci of identical radii and latitude, we identify satellite 1 as the reference, where e1 and i1 are the maximum eccentricity and inclination, respectively, of the satellites in the constellation. Satellite 2 represents any other satellite in the constellation, where e2/e1 can be 0.0, 0.2, 0.4, 0.6, 0.8 and i2/i1 can be 0.0, 0.2, 0.4, 0.6, 0.8.

### Case A

We first examine the loci where all perigees are aligned to their ascending node, i.e., w1=0, delta w=0. This results in the following four solutions:

Identical radii: (1) M2=Q+90, M1=M2−delta RA, (2) M2=Q+270, M1=M2−delta RA

Identical latitude: (1) M1=Z, M2=M1+delta RA, (2) M1=Z+180, M2=M1+delta RA

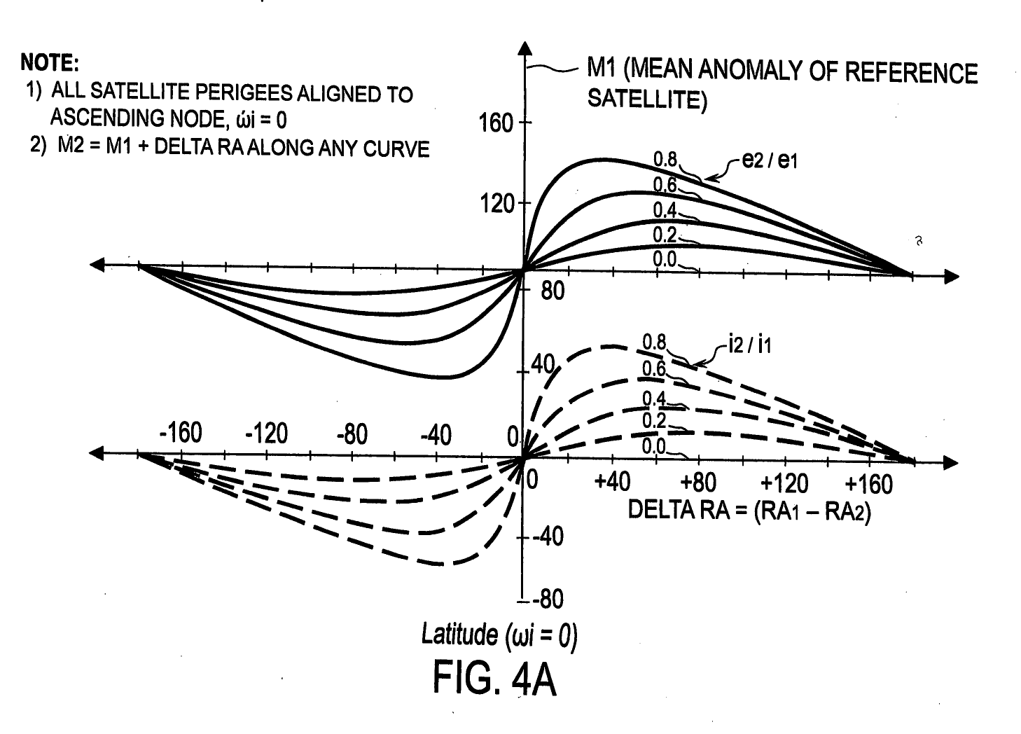

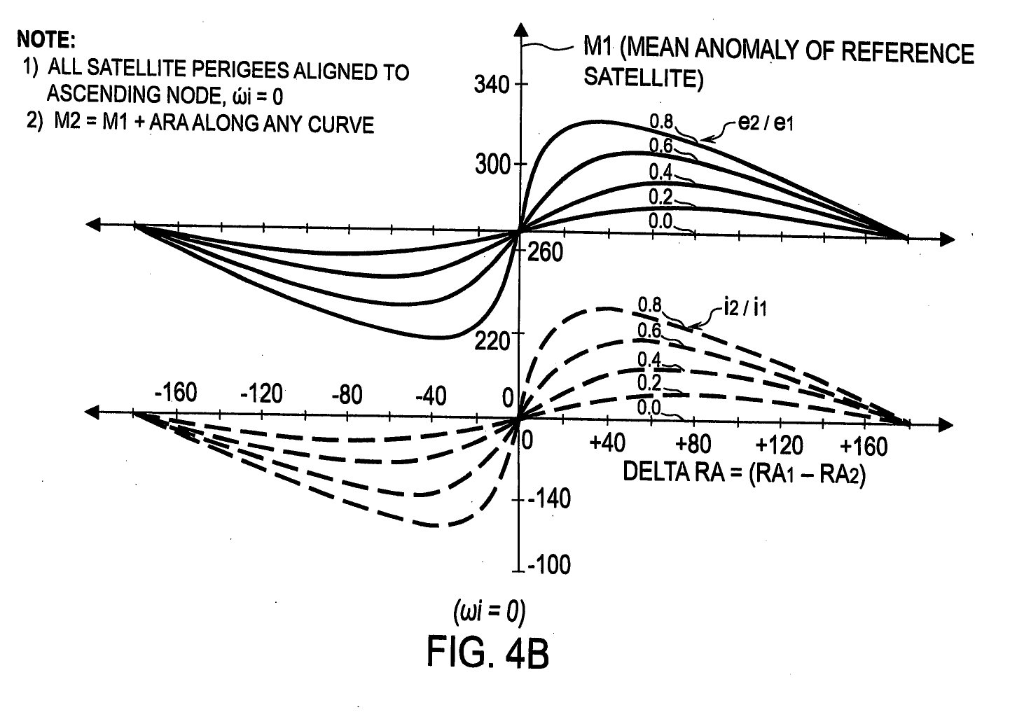

FIGS. 4a & 4b illustrate each of the four solutions as a family of curves with parameter (e2/e1) or (i2/i1). The X axis defines the relative right ascension (delta RA=RA1−RA2) of any satellite relative to the reference satellite. The Y axis defines the mean anomaly, M1, of the reference satellite at which either the radii or latitude are identical for the ith (i>1) satellite and the reference satellite. The mean anomaly, M2, can be readily defined as M2=M1+delta RA. The “solid family of curves” defines the loci of all solutions where radii are identical as a function of (e2/e1). The “dashed family of curves” define the loci of all solutions where latitude is identical as a function of (i2/i1). Note that all the satellites in the constellation have identical radii at M1=90, 270 or 90 deg from the line of nodes, independent of eccentricity. This is expected with all perigees positioned at the node. Note further that all the satellites in the constellation have identical latitude at M1=0, 180 or 0 deg along the line of nodes, independent of inclination. This is expected with all nodes collinear. An important conclusion is there is always latitude separation at identical radii and radial separation at identical latitude for delta RA=0, 180. The more significant conclusion is that no matter what the relative delta RA, there is no overlap of either family of curves, so that no collision is possible between any of the satellites in the constellation.

### Case B

We next examine the loci where the reference satellite has its perigee aligned 90 deg ahead of the ascending node, i.e., w1=90 but all other satellites have their perigees aligned along the ascending node, i.e., delta w=90. These assumptions result in the following four solutions:

### Identical Radii:

(1) M2=Q+90, M1=M2−(delta RA+90),

(2) M2=Q+270, M1=M2−(delta RA+90)

### Identical Latitude:

(1) M1=Z−90, M2=M1+(delta RA+90),

(2) M1=Z+90, M2=M1+(delta RA+90)

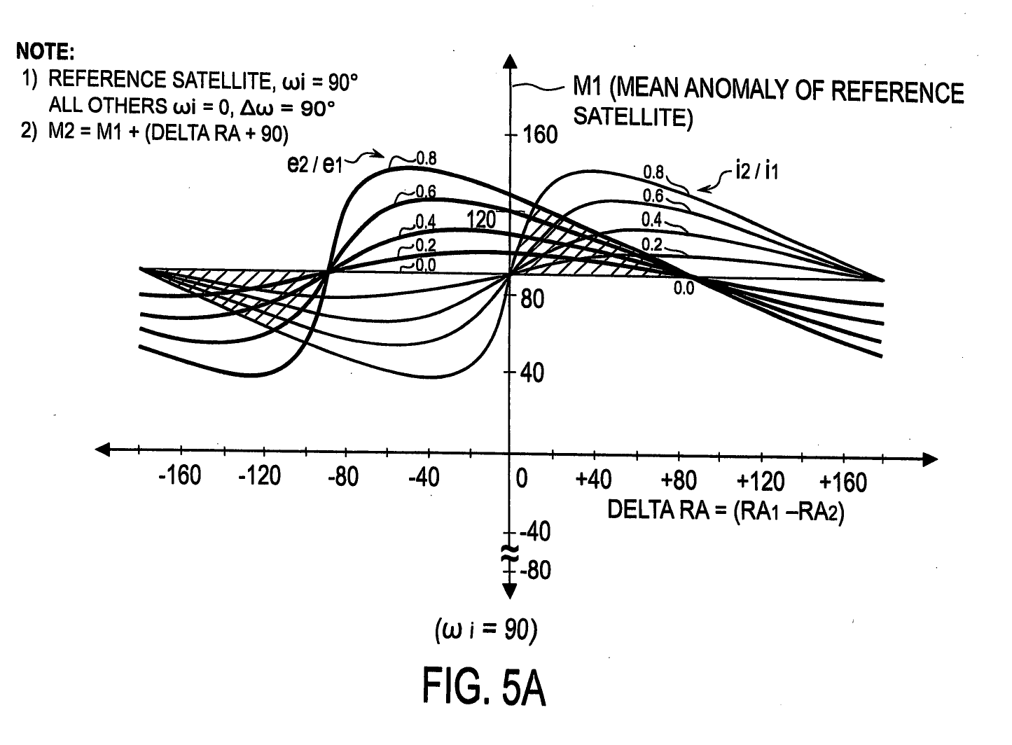

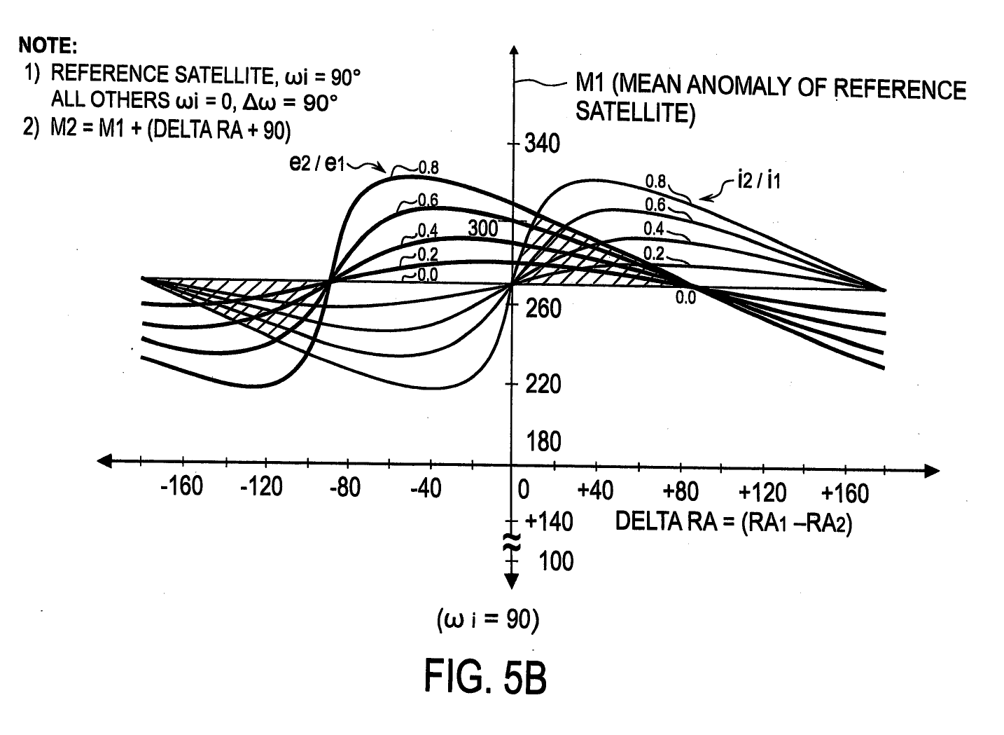

FIGS. 5a & 5b illustrate each of the four solutions as a family of curves with parameter (e2/e1) or (i2/i1). Note first that the “solid family of curves” defining the loci of all solutions where radii are equal have shifted to the left on the X axis by 90 deg, since delta w is equivalent to adding 90 deg to delta RA. Note second that the “dashed family of curves” defining the loci of all solutions where latitude is equal have shifted down on the Y axis by 90 deg, since perigee of the reference satellite has been moved forward 90 deg ahead of its node, i.e., w1=90. These shifts cause significant common areas where the reference satellite can have identical radius and latitude with other satellites in the constellation. These areas are illustrated by the shaded regions in FIGS. 5a & 5b. Comparison of FIGS. 4a & 4b with FIGS. 5a & 5b, and noting the shift characteristics with w1, suggests that −30<(delta w)<30 will insure either differential radius or latitude protection from collision.

### Case C

We finally examine the loci where the reference satellite has its perigee aligned 180 deg ahead of the ascending node, i.e., w1=180 but all other satellites have their perigees aligned along the ascending node, i.e., delta w=180. These assumptions result in the following four solutions:

### Identical Radii:

(1) M2=Q+90, M1=M2−(delta RA+180),

(2) M2=Q+270, M1=M2−(delta RA+180)

Identical Latitude:

(1) M1=Z−180, M2=M1+(delta RA+180),

(2) M1=Z, M2=M1+(delta RA+180)

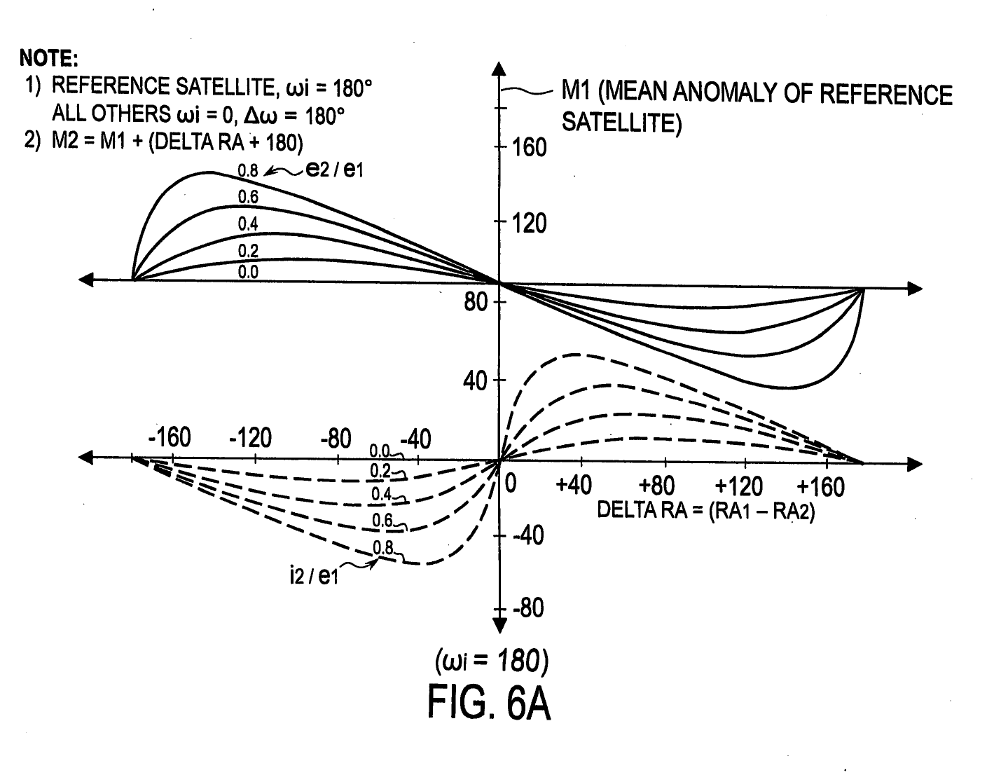

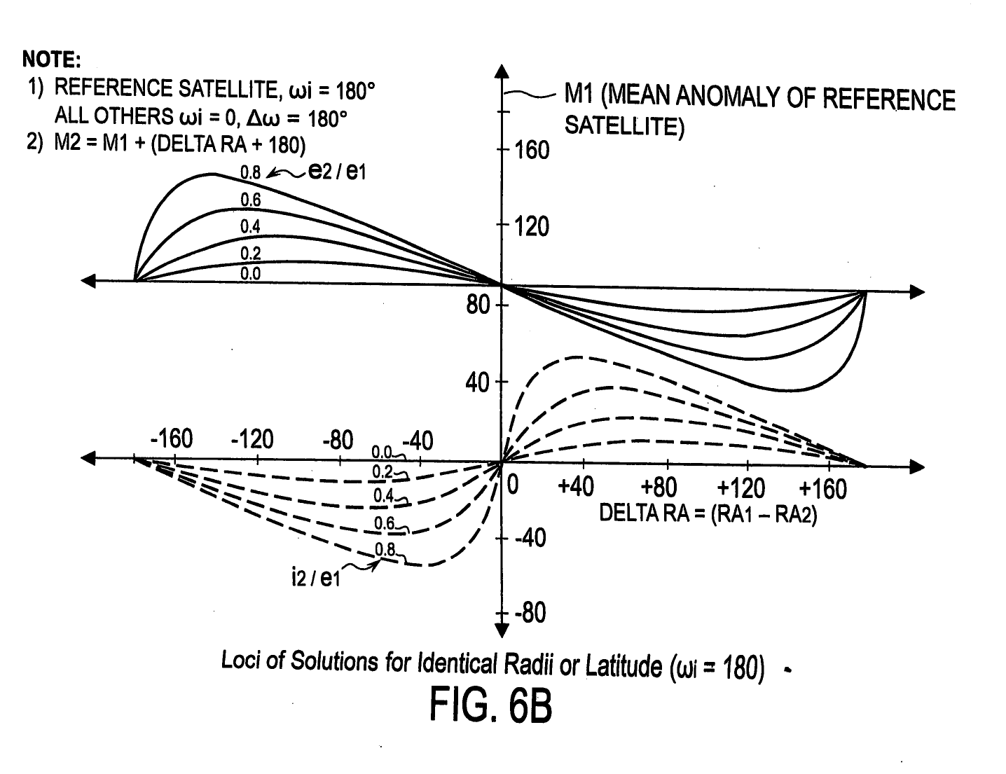

FIGS. 6a & 6b illustrate each of the four solutions as a family of curves with parameter (e2/e1) or (i2/i1). Note that the “solid family of curves” defining the loci of all solutions where radii are equal have shifted to the left on the X axis by 180 deg (as expected), since once again delta w is equivalent to adding 180 deg to delta RA. Note also that the “dashed family of curves” defining the loci of all solutions where latitude is equal have shifted down on the Y axis by 180 deg from the w1=0 solution, yielding the same pair of loci for the w1=0 solution. The most significant conclusion from these figures is that no matter what the relative delta RA, there is no overlap of either family of curves, so that no collision is possible between any satellites in this constellation. Comparison of FIGS. 5a & 5b with FIGS. 6a & 6b, and noting the shift characteristics with w1, suggests that 150<(delta w)<210 will also insure either differential radius or latitude protection from collision.

### Implementation of Invention

### A Constellation of 10 Satellites that Approach the Zenith & Nadir at Same Time

In a first preferred embodiment of the present invention ten satellites are positioned at a single longitude and maintained sufficiently separated that communication through them can be carried out without interference. We choose 5 satellites having a RA=90 deg and 5 satellites having a RA=270 deg. All satellites have their perigees aligned along the ascending node, i.e., w=0. The set of 5 satellites in each RA group have relative e and i ratios of (e2/e1=0.2, i2/i1=0.2), (e2/e1=0.4, i2/i1=0.4), (e2/e1=0.6, i2/i1=0.6), (e2/e1=0.8, i2/i1=0.8), and (e1=1,i1=1).

All satellites in each group have radial or latitude separation everywhere in the orbit per the above analysis. Since w=0 for all satellites, each satellite in a group with the same RA will have the same mean anomaly and reach the zenith and nadir at the same time. Since the nodes of the two groups are separated by 180 deg and perigees are separated by 180 deg, there will always be radial separation at the nodes between the two groups. Since (RA+M) must be the same for all satellites everywhere in the orbit, the mean anomaly of one group is 180 deg out of phase with the second group. This implies that as one group approaches the zenith, the other group is approaching the nadir. This always provides latitude differential when radial separation can become zero. The result is a simultaneous view of 10 inclined geosynchronous satellites at the same longitude, with the inclination of this set increasing at ˜0.87 deg/yr along the RA=90 deg axis.

### A Pentagon Constellation of 5 Satellites Having the Same Inclination Progressively Rising to the Zenith Every 72 deg of Orbit Motion or 4.8 Hours

A second preferred embodiment is outlined as follows:

We choose five satellites having right ascensions of 270 deg, (270+72) deg, (270+144) deg, (270−72) deg, and (270−144). All satellites have their perigees aligned to their ascending nodes, i.e., w=0. Each satellite has identical eccentricity and inclination, i.e., ej/e1=1, and ij/i1=1 for j=2-5.

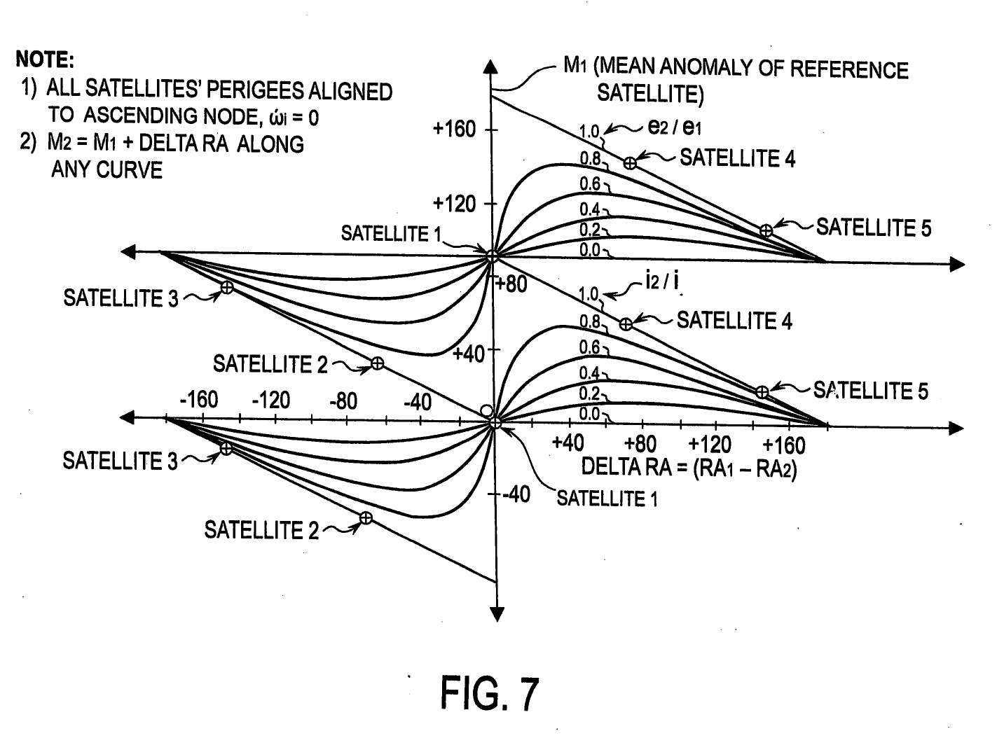

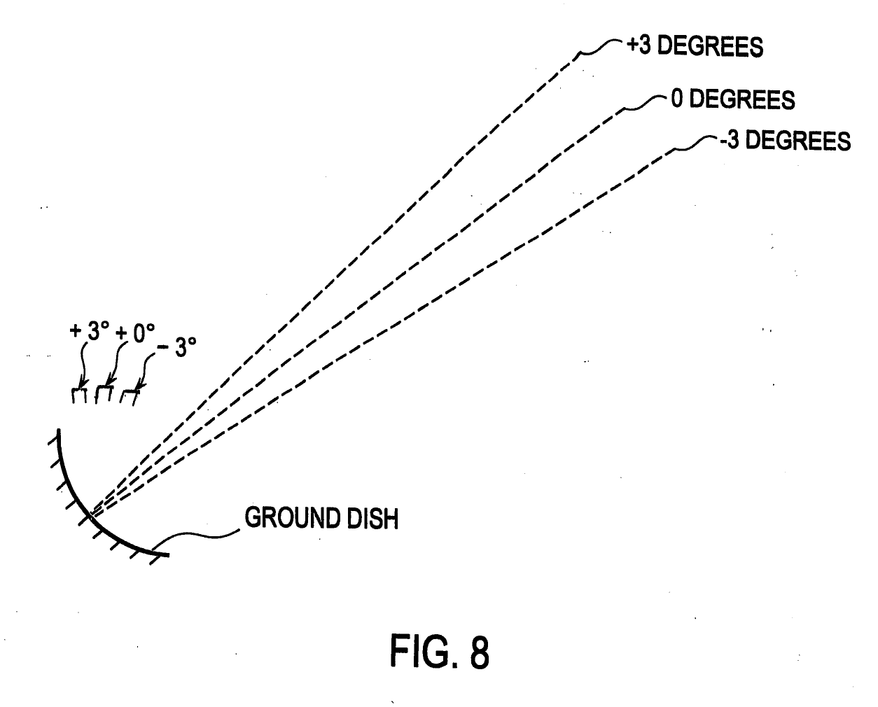

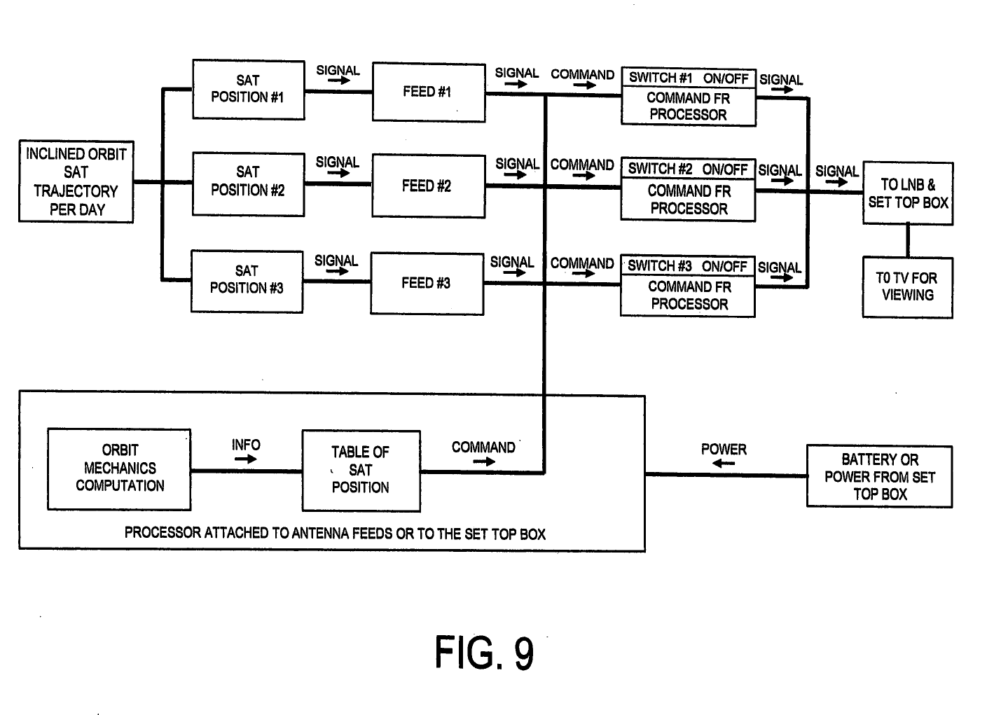

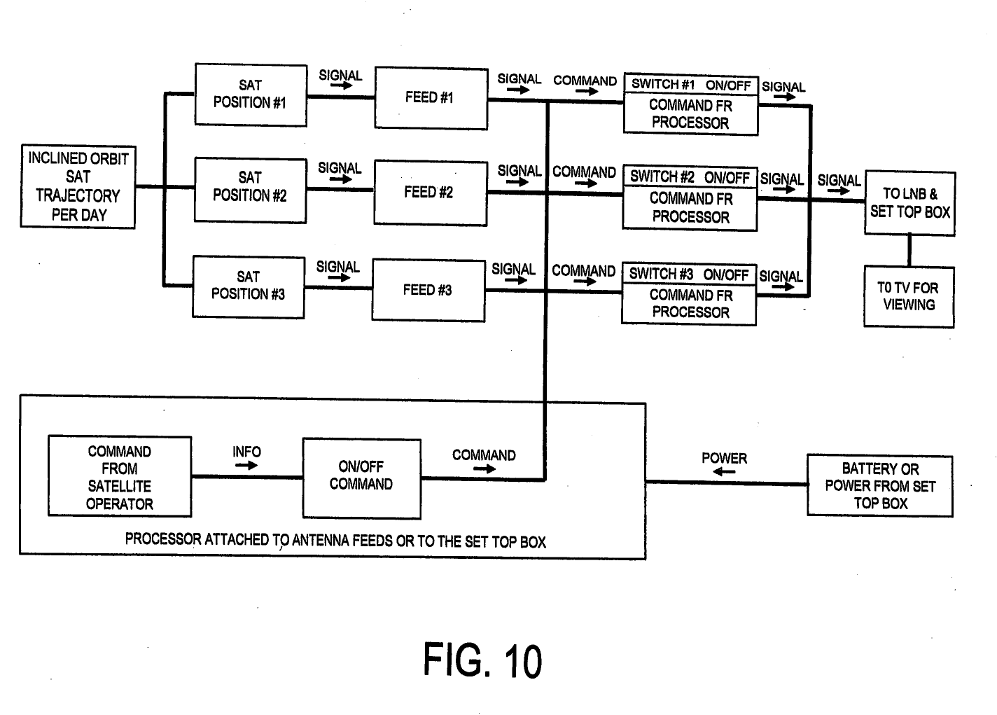

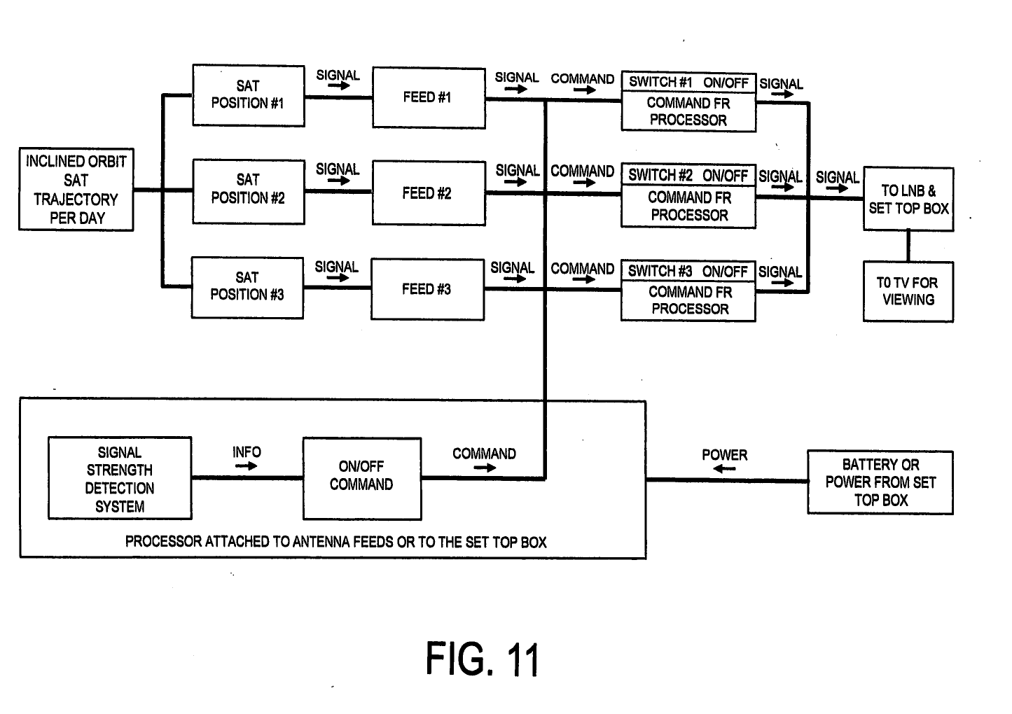

FIG. 7 is an expanded version of FIG. 4a that includes parametric curves where ej/e1=1 and ij/i1=1. Note that any collision where both radial and latitude separation are both zero are limited to delta RA=0.

All satellites in this group (1-5) under consideration have radial or latitude separation everywhere in the orbit as shown in FIG. 7 where:

Satellite 1 (the reference satellite) has e1/e1=1, i1/i1=1, RA1=270, delta RA=0

Satellite 2 has e2/e1=1, i2/i1=1, RA2=(270+72), delta RA=(RA1-RA2)=−72

Satellite 3 has e3/e1=1, i3/i1=1, RA3=(270+144), delta RA=(RA1-RA3)=−144

Satellite 4 has e4/e1=1, i4/i1=1, RA4=(270−72), delta RA=(RA1-RA4)=+72

Satellite 5 has e5/e1=1, i5/i1=1, RA5=(270−144), delta RA=(RA1-RA5)=+144

Since w=0 for all satellites and the inertial location of all satellites (RA+w+M) must be identical for all satellites at the same station longitude, (RA+M) must be identical for all the satellites in this constellation. The reference satellite has (RA+90) at the zenith of its orbit.

When satellite 1 is at the zenith, (RA1+90)=360 deg. The mean anomaly, M, of the other satellites in the constellation at this time are

Satellite 2 has (RA2+M2)=360, or M2=360−342=+18

Satellite 3 has (RA3+M3)=360, or M3=360−414=−54=+306

Satellite 4 has (RA4+M4)=360, or M4=360−198=+162

Satellite 5 has (RA5+M5)=360, or M5=360−126=+234

The mean anomalies in the constellation can be defined relative to the reference satellite as M2=M1-72, M3=M1-144, M4=M1-216, and M5=M1-288 deg. The constellation forms a pentagon in the common orbit plane where the satellites rotate to the zenith position every 72 deg of orbit motion or 4.8 hrs. This rotating pentagon always allows 3 of the 5 satellites to have different latitudes to combine RF signals. The inclination of this set increases ˜0.87 deg/yr along the RA=90 deg axis.

### Ground Transmitting Radios

As explained above a number of satellites (such as 5 or 10) can be positioned within the same east-west box at the same longitudinal position without north-south station keeping. However to communicate with them separately ground antenna must be capable of directing communication beams to the separate satellites as they move around in distance from the center of the earth and within their common east west box. In addition, user ground antennas should be able to receive and transmit signals to and from the satellites as prescribed by communication architecture and protocols. In some embodiments two or more of the satellites may be too close together to effectively communicate with them separately depending on the design of the antenna systems utilized. In that case some of the communication links can be cut off in accordance with the protocols.

Advantages of using such a constellation for communications are many fold: First, the effective bandwidth can be increased, approximately equal to the number of satellites in this constellation minus the time when the satellites are too closed together so some of the satellites' communication links need to be shut off due to interference. Second, by using this strategy of dividing the data among the satellites within the constellation, it is difficult for an unwanted party to intercept and decipher the data. Effectively, it is similar to the spread spectrum strategy for secure communications. Third, since the satellites effectively do not have to perform North-South station keeping, launch weight and launch cost can be reduced significantly and thus, the cost of communications and the life of the assets can be extended.

In preferred embodiments a satellite operations center manages the constellation, including monitoring the health and safety of the satellites and constellation. It also monitor and control the positions of each satellite within the constellation including East-West station keeping. A network operations center manages the communications link and the payload performance. It gets the satellites locations, and health information from the operations center and distributes the communications among the satellites within the constellation based on the satellite positions, shut off or turn on the transponders based on a set of criteria that include if the satellites are too closed to cause interference, etc.

The User Terminals that include a multiple feeds antenna, or a set of phase array antenna, a user terminal that include algorithms and processors that has both stored information and information transmitted from the satellite in real time. It takes the signals from the user antenna and performs the functions of combination and decipher of the signals from the satellites to obtain the communication data.

One example of is a multiple feeds antenna where a three-feed antenna can receive signal from a satellite that is in inclined orbit at + or −3 degrees inclinations. Another alternative is an 11 element multiple feeds antenna feed-array. In another scheme, instead of switching on the feed horn that receive maximum signals from the satellite signal closest (and therefore strongest) to the feed position, one can optimize the signal using digital beam forming technology by digitally combine the signals from the feeds and computationally process the signals to obtain optimum performance. Digital beam forming technology is an established technology proven in a number of existing systems. In preferred embodiments we used Ku band rectangular feeds with a vertical dimension of 1.13 wavelength and horizontal dimension of 1.65 wavelength or 2.84 cm×4.12 cm.

In addition the some of the ground based antenna techniques described in the parent application may be utilized for communicating with the constellation of satellites described above.

While the above description contains many specifications, the reader should not construe these as a limitation on the scope of the invention, but merely as exemplifications of preferred embodiments thereof. For example, the number of feed horns could more or less than three in the ground based antennas. As indicated many antenna designs can be adapted for use with the present invention. A variety of techniques can be utilized to control the ground base antenna to keep them in touch with the satellite. Accordingly the reader is requested to determine the scope of the invention by the appended claims and their legal equivalents, and not by the examples given above.

What is claimed is:

1. A method of flying a constellation of inclined geosynchronous satellites at the same station longitude with specific spacing but without the possibility of collision, said method comprising the steps of:
A) determining the basic equations defining the initial positions of a plurality of at least five satellites in a geosynchronous constellation such that the satellites will remain synchronized at the same longitudinal location for a plurality of years with little or no north-south positioning,
B) positioning the plurality of satellites in determined positions,
C) controlling the satellites using east-west positioning with little or no north-south positioning.

2. The method as in claim 1 wherein the number of satellites in the constellation is five satellites.

3. The method as in claim 1 wherein the number of satellites in the constellation is ten satellites.
